(19) United States
(12) Patent Application Publication
(10) Pub. No.: US 2010/0109566 A1
(43) Pub. Date: May 6, 2010

(54) Control Circuit for Light Emitting Diode and Light Emitting Device Having the Same

(76) Inventor: Jin Goo Kang, Kyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/593,968

(22) PCT Filed: Apr. 11, 2008
(86) PCT No.: PCT/KR08/02075

§ 371 Date: Sep. 30, 2009

(30) Foreign Application Priority Data
Apr. 12, 2007 (KR) 10-2007-0036116

(51) Int. Cl. H05B 37/02

(52) U.S. Cl. 315/294

(57) ABSTRACT

Disclosed are a control circuit for a light emitting diode and a light emitting device having the same. The control circuit for the light emitting diode comprises a red LED, a green LED and a blue LED, a driver which outputs a first control signal and a second control signal based on a 2-bit combination and a driving circuit which sequentially turns on/off the LEDs according to a state of the first control signal and the second control signal that are output from the driver.

### TECHNICAL FIELD

The embodiment relates to a control circuit for a light emitting diode and a light emitting device having the same.

### BACKGROUND ART

Light Emitting Diodes (LEDs) produce light having various colors by using compound semiconductor materials based on GaAs, AlGaAs, GaN, InGaN, InGaAlP, etc. Such LEDs have been applied to various fields such as a lightening indicator, a character indicator and an image indicator (for example, an LCD), in which at least one LED is used to display a unique color or various colors.

### Disclosure of Invention

### Technical Problem

The embodiment provides a control circuit for a light emitting diode and a light emitting device having the same, capable of sequentially controlling light emitting diodes according to colors thereof.

The embodiment provides a control circuit for a light emitting diode and a light emitting device having the same, capable of sequentially controlling ON/OFF modes of a red LED, a green LED and a blue LED according to a state of a 2-bit control signal.

### Technical Solution

An embodiment provides a control circuit for a light emitting diode comprising; a red LED, a green LED and a blue LED; a driver which outputs a first control signal and a second control signal based on a 2-bit combination; and a driving circuit which sequentially turns on/off the LEDs according to a state of the first control signal and the second control signal that are output from the driver.

An embodiment provides a light emitting device comprising; a package body having a cavity; first to third color LEDs disposed in the cavity; a driving circuit, which is connected to first electrodes of the first to third color LEDs in a predetermined area of the package body to turn on/off the first to third color LEDs; a plurality of control signal terminals, which are disposed at a first side of the package body and are connected to the driving circuit; and a ground terminal, which is disposed at a second side of the package body and is connected to a second electrode of the first to third colors.

An embodiment provides a light emitting device comprising; a substrate, on which a light emitting diode comprising first to third LED chips is disposed in a form of an array; a driving circuit connected to a first electrode and a second electrode of the LED chips through four signal lines to sequentially operate the LED chips; and a driver, which outputs a first control signal and a second control signal having a 2-bit combination to the driving circuit.

### Advantageous Effects

According to the embodiment, a lightening operation of a red LED, a green LED and a blue LED can be controlled according to a 2-bit control signal.

According to the embodiment, ON/OFF operations of a red LED, a green LED and a blue LED can be sequentially controlled according to a 2-bit control signal.

According to the embodiment, two electrodes of three color LEDs are connected through four signal lines, so that a line pattern of a substrate is simplified and a sufficient space is ensured for the substrate.

The embodiment provides a control circuit for a light emitting diode, which is applied to an FSC (Field Sequential Color) type display device and a light unit having the same.

### BRIEF DESCRIPTION OF THE DRAWINGS

FIG. 1 is a block diagram representing a control circuit for a light emitting diode according to an embodiment;

FIG. 2 is a plan view representing a light emitting device having a driving circuit shown in FIG. 1;

FIG. 3 is a sectional view taken along line A-A of FIG. 2;

FIG. 4 is a view representing a display device adopting a side-view type light unit having the driving circuit shown in FIG. 1;

FIG. 5 is a view representing a display device adopting a top-view type light unit having the driving circuit shown in FIGS. 1; and

FIG. 6 is a plan view representing an example of a light emitting unit shown in FIG. 5.

### BEST MODE FOR CARRYING OUT OF THE INVENTION

Hereinafter, the embodiment of the present invention will be described with reference to the accompanying drawings.

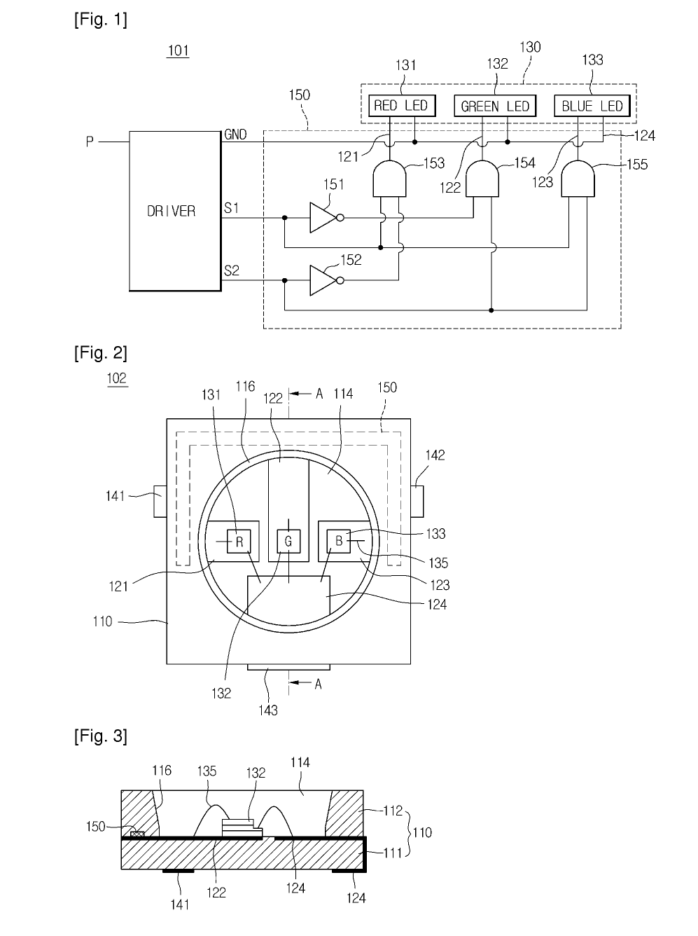

FIG. 1 is a view representing a control circuit for a light emitting diode according to an embodiment.

As shown in FIG. 1, a control circuit 101 comprises a light emitting diode unit 130, a driver 140 and a driving circuit 150.

The light emitting diode unit 130 comprises a red light emitting diode 131, a green light emitting diode 132 and a blue light emitting diode 133. At least one of the red, green and blue light emitting diodes 131, 132 and 133 comprises at least one LED. The red, green and blue light emitting diodes 131, 132 and 133 are turned on by the driving circuit 150 at different time points.

The light emitting diode unit 130 does not limit three color LEDs(a red LED, a green

LED and a blue LED). The LEDs may be changed to other color LED (for example, an yellow LED) and can be added other color LED.

The driver 140 outputs power to the driving circuit 150 by converting the power into 2-bit control signals S1 and S2. The driving circuit 150 sequentially controls an operation of the light emitting diodes 131, 132 and 133 according to the control signals S1 and S2.

The driver 140 outputs the two control signals S1 and S2 in the form of a 2-bit logic signal. The 2-bit logic signal comprises states of 00, 10, 01 and 11. The state of signal 1 represents a high level, and the state of signal 0 represents a low level.

The driver 140 performs a time division with respect to a first control signal S1 and a second control signal S2 in the order of 00, 10, 01 and 11 to output the control signals S1 and S2 to the driving circuit 150. Such a driver 140 outputs the control signals S1 and S2 having a 2-bit combination during a period or a frame.

The driving circuit 150 is connected between the driver 140 and the light emitting diodes 131, 132 and 133, and sequentially drives the light emitting diodes 131, 132 and 133 according to the state of the first and second control signals S1 and S2 that are output from the driver 140.

The driving circuit 150 comprises inversion logic devices 151 and 152, and AND logic devices 153, 154 and 155.

The inversion logic devices 151 and 152 serve as an inverter that outputs an input signal into an inverted signal, and comprises a first inversion logic device 151 for inverting the first control signal S1 and a second inversion logic device 152 for inverting the second control signal S2.

The AND logic devices 153, 154 and 155 are prepared in the form of an AND gate, which ANDs two input signals to output a single signal, and comprise a first AND logic device 153, a second AND logic device 154 and a third AND logic device 155.

The first to third AND logic devices 153, 154 and 155 are connected to the red light emitting diode 131, the green light emitting diode 132 and the blue light emitting diode 133, respectively. The inversion logic devices 151 and 152, and the AND logic devices 153, 154 and 155 are realized as a combination circuit of a transistor.

A buffer may be disposed between the inversion logic devices 151 and 152 and the driver 140. In addition, the buffer may be provided at an input terminal of the inversion logic devices 151 and 152, or an input terminal of the AND logic devices 153, 154 and 155.

The first inversion logic device 151 inverts the first control signal S1 to output the inverted first control signal to the second AND logic device 154. The second inversion logic device 152 inverts the second control signal S2 to output the inverted second control signal to the first AND logic device 153.

The first AND logic device 153 ANDs the input first control signal S1 and the inverted signal of the second inversion logic device 152 to output a resultant signal to a first electrode 121 of the red light emitting diode 131.

The second AND logic device 154 ANDs the inverted signal of the first inversion logic device 151 and the input second control signal S2 to output a resultant signal to a first electrode 122 of the green light emitting diode 132.

The third AND logic device 155 ANDs the input first and second control signals S1 and S2 to output a resultant signal to a first electrode 123 of the blue light emitting diode 133.

The red, green and blue light emitting diodes 131, 132 and 133 are driven by signals applied to the first electrodes 121, 122 and 123. A second electrode 124 of the red, green and blue light emitting diodes 131, 132 and 133 are connected to a ground terminal GND.

Such a driving circuit 150 turns on/off the red, green and blue light emitting diodes 131, 132 and 133 by using two control signal terminals and the single ground terminal GND. An arrangement of devices of the driving circuit 150 and a sequence of ON/OFF operations may be changed according to the embodiments.

Table 1 represents an example of an operation mode of the light emitting diode according to the control signals of the driver and the driving circuit.

TABLE 1

| FIRST CONTROL | SECOND CONTROL | |
|---|---|---|
| SIGNAL | SIGNAL | LED ON/OFF |
| 0 | 0 | LED OFF |
| 1 | 0 | RED LED ON |
| 0 | 1 | GREEN LED ON |
| 1 | 1 | BLUE LED ON |

As shown in TABLE 1, when the first control signal S1 and the second control signal S2 of the driver 140 are input to the driving circuit 150 in the 00 state, the first inversion logic device 151 and the second inversion logic device 152 output a HIGH signal, respectively. In this case, the first to third AND logic devices 153, 154 and 155 output a LOW signal based on the first signal S1 or second signal S2. Accordingly, the light emitting diodes 131, 132 and 133 become an OFF state.

When the first control signal S1 and the second control signal S2 of the driver 140 are input to the driving circuit 150 in the 10 state, the first AND logic device 153 ANDs the first control signal S1 and the inverted signal of the second inversion logic device 152 to output a high signal to the red light emitting diode 131. Accordingly, the red light emitting diode 131 becomes an ON state and the remaining light emitting diodes 132 and 133 become an OFF state.

When the first control signal S1 and the second control signal S2 are input to the driving circuit 150 in the 01 state, the second AND logic device 154 ANDs the inverted signal of the first inversion logic device 151 and the second control signal S2 to output a high signal to the green light emitting diode 132. Accordingly, the green light emitting diode 132 becomes an ON state, and the remaining light emitting diodes 131 and 133 become an OFF state.

When the first control signal S1 and the second control signal S2 of the driver 140 are input to the driving circuit 150 in the 11 state, the third AND logic device 155 ANDs the first control signal S1 and the second control signal S2 to output a high signal to the blue light emitting diode 133. Accordingly, the blue light emitting diode 133 becomes an ON state, and the remaining light emitting diodes 131 and 132 become an OFF state.

The driving circuit 150 enables an LED-OFF mode, a red LED-ON mode, a green LED-ON mode and a blue LED-ON mode according to a logical state of the 2-bit control signals S1 and S2.

In addition, the driving circuit 150 sequentially controls the ON/OFF sequence of three color LEDs (a red LED, a green LED and a blue LED) or a plurality of light emitting diodes according to a time division state of the 2-bit control signals S1 and S2, so that the multi-color LEDs or a plurality of LEDs are sequentially operated. The ON/OFF sequence of the three color LEDs may be changed according to the embodiments.

Such a driving circuit 150 is realized in an LED package or is realized as a circuit on a printed circuit board.

FIG. 2 is a view representing a light emitting device comprising the driving circuit shown in FIG. 1, and FIG. 3 is a sectional view taken along line A-A of FIG. 2.

As shown in FIGS. 2 and 3, a light emitting device 102 comprises a package body 110 having a cavity 114, light emitting diodes 131, 132 and 133 and a driving circuit 150.

The package body 110 comprises a printed circuit board (PCB). The package body 110 is made from silicon, ceramic, such as silicon carbide (SiC) and aluminum nitride (AlN), thermosetting resin, such as poly phthal amide (PPA) and liquid crystal polymer, and a mixture thereof.

The package body 110 comprises a lower substrate 111 and an upper substrate 112, which are vertically stacked, and a predetermined electrode pattern is formed on the lower substrate 111.

The cavity 114 is formed at the center of the upper substrate 112. The cavity 114 has a depth sufficient for exposing the electrode pattern of the lower substrate 111 to the outside. Such a package body 110 can be obtained by stacking substrates or can be integrally formed through an injection molding process.

Electrodes 121, 122, 123 and 124 are formed on the lower substrate 111, and the light emitting diodes 131, 132 and 133 are electrically connected to the electrodes 121, 122, 123 and 124. In addition, an inner wall 116 of the upper substrate 112 may be inclined, and may be coated with a light reflection material.

The light emitting diodes 131, 132 and 133 are provided in the form of chip, and are connected to first electrodes 121, 122 and 123 and a second electrode 124 through a wire 135. The first electrodes 121, 122 and 123 are connected to the driving circuit 150, and the second electrode 124 is connected to a ground terminal GND. The light emitting diodes 131, 132 and 133 can be connected to the first and second electrodes 121, 122, 123 and 124 through a wire bonding scheme, a die bonding scheme and a flip boding scheme according to the type of a semiconductor chip.

A first control signal terminal 141, a second control signal terminal 142 and a ground terminal 143 are disposed at an outer side of the package body 110.

The driving circuit 150 is provided on the lower substrate 111 of the package body 110 in the form of a combination of MOS transistor. Such a driving circuit 150 sequentially controls a lightening sequence of the three color LEDs 131, 132 and 133 by using the three signal terminals 141, 142 and 143.

The driving circuit 150 sequentially turns on/off the red light emitting diode 131, the blue light emitting diode 132 and the green light emitting diode 132 as shown in TABLE 1 according to the state of 2-bit control signals which are input to the first and second control signal terminals 141 and 142.

Resin material such as transparent epoxy or silicon is molded in the cavity 114. The resin material may have a flat shape, a concave lens shape or a convex lens shape according to a surface state of the resin material.

The light emitting device 102 sequentially controls an LED OFF mode and ON/OFF modes of color LEDs according to a sequence of the 2-bit logical signals, which are input into the first and second control signal terminals 141 and 142.

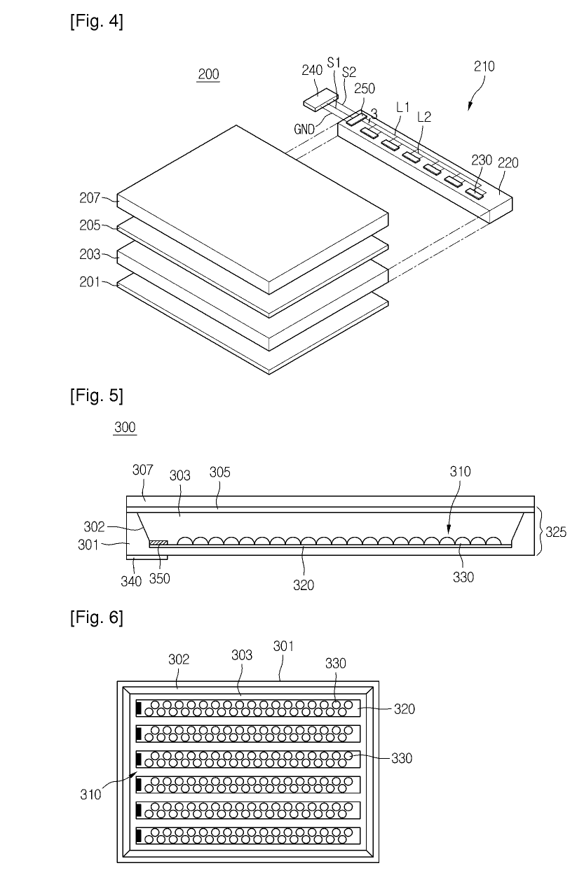

FIG. 4 is a perspective view representing a side-view type display device having the driving circuit of FIG. 1.

As shown in FIG. 4, a display device 200 comprises a reflection plate 201, a light guide plate 203, an optical sheet 205, a display panel 207 and a light emitting unit 210. The reflection plate 201, the light guide plate 203, the optical sheet 205 and the light emitting unit 210 may serve as a light unit.

The reflection plate 201 reflects light, which is leaked toward the lower side of the light guide plate 203. Such a reflection plate 201 may comprise a plate having high reflectivity or can be coated on a chassis.

The light emitting plate 203 guides incident light into a light emitting area and allows the incident light to have an optical distribution of a surface light source. A predetermined pattern may be formed at one side or both sides of the light guide plate 203.

The optical sheet 205 comprises at least one of a diffusion sheet, a horizontal prism sheet, a vertical prism sheet and a brightness enhancement sheet. The diffusion sheet diffuses incident light, and the horizontal prism sheet and the vertical prism sheet concentrate light in a horizontal direction and a vertical direction, respectively. The brightness enhancement sheet enhances brightness. Such an optical sheet 205 allows light to be irradiated to the display panel 207 with a uniform brightness distribution.

A polarizer (not shown) may be attached to an upper side and/or a lower side of the display panel 207.

The display panel is realized as an LCD panel, and the display panel displays information by allowing light irradiated from the optical sheet 205 to pass therethrough.

The display panel 207 comprises transparent substrates, which face each other, and a liquid crystal layer interposed between the transparent substrates. The display panel 207 adopts an FSC (Field Sequential Color) scheme, in which an image signal is obtained by allowing red light, green light and blue light to pass through the transparent substrate, without using a color filter. If the display panel 207 adopts the FSC-scheme, a single main frame is divided into three sub-frames of red, green and blue, in which data access, response of liquid crystal and light transmission are sequentially performed in each sub-frame similarly to those of the single main frame.

The light emitting unit 210 is disposed on an incident surface of the light guide plate 203, and sequentially emits red light, green light and blue light. The three-color light is sequentially incident into the light guide plate 203.

The light emitting unit 210 comprises a substrate 220 and a light emitting diode 230. A driving circuit 250 is disposed at a side of the substrate 220, and sequentially receives the two control signals S1 and S2 from a driver 240.

A plurality of light emitting diodes 230 are disposed on a surface of the substrate 220 in the form of an array, and a red LED chip, a blue LED chip and a green LED chip are mounted on each light emitting diode in the form of a package. The three color LED chips may be mounted on a single diode in the form of a package, or may be separately mounted on the red LED, blue LED and green LED, respectively.

The LED chips of the light emitting diodes 230 are turned on/off by the driving circuit 250. The driving circuit 250 has a structure identical to that shown in FIG. 1, and three signal lines L1 are connected to first electrodes of the color LED chips and a ground line L2 is connected to a second electrode of the LED chips.

The driving circuit 250 controls an LED-OFF operation, a red LED-ON operation, a green-ON operation, and a blue LED-ON operation according to a combination of the 2-bit control signals S1 and S2 such that red/green/blue light is sequentially output to the FSC-type display panel 207.

The driving circuit 250 controls ON/OFF operations of the color LED chips of the light emitting diode 230 based on a logical combination and a sequence of the two control signals S1 and S2. The driving circuit 250 can be connected to the light emitting diodes 230 through the three signal lines L1 and the ground line L2, thereby simplifying a circuit structure of the substrate 220.

According to the FSC-type display device 200, when the three LED chips are used as a light source, the driving circuit 250 sequentially turns on/off the three color LEDs of the light emitting unit 210 according to the control signals S1 and S2 of the driver 240.

The display device 200 having the light emitting unit 210 is applied to a portable phone, a computer or a display device used for a digital broadcasting.

FIG. 5 is a perspective view representing a top-view type display device according to the embodiment, and FIG. 6 is a plan view representing an example of a light emitting unit of FIG. 5.

As shown in FIG. 5, a display device 300 comprises a bottom cover 301, an optical sheet 305, a display panel 307, a light emitting unit 310, a driver 340 and a driving circuit 350. The bottom cover 301 is prepared in the form of vessel, and comprises metal such as aluminum, magnesium, zinc, titanium, tantalum, hafnium and niobium. An inner circumference of the bottom cover 301 has a side surface 302, which has an inclination structure to reflect light.

The light emitting unit 310 is disposed in the bottom cover 301 to radiate light in a vertical upward direction.

The optical sheet 305 comprises at least one of a diffusion sheet, a prism sheet, and a brightness enhancement film to uniform a brightness of light radiated to the display panel 307.

The light emitting unit 310 comprises substrates 320 and a light emitting diode 330. A plurality of light emitting diodes 330 are disposed on the substrate 320 in the form of an array. The light emitting diodes 330 are provided as a three color light emitting diode chip (for example, a red/green/blue LED chip) or are separately provided as a color light emitting diode.

The driving circuit 350, which is identical to the driving circuit shown in FIG. 1, is disposed at a side of the substrate 320. The driving circuit 350 sequentially controls an ON/OFF operation of the three color light emitting diode chips according two control signals that are output to the driver 340. That is, the driving circuit 350 controls the ON/OFF operation of the three color light emitting diodes chips through four signal lines, thereby simplifying a circuit design and ensuring a space for the circuit. The driving circuit 350 is disposed on each of light emitting diodes, is disposed on each of the substrates 320, or is disposed on a light unit 325. The light unit 325 comprises the bottom cover 301, the optical sheet 305 and the light emitting unit 310.

Accordingly, the display panel 307 allows red light, green light and blue light to pass through three sub-frames, respectively such that each sub-frame is operated in the similar mode to that of a main frame of the display 300, in which a data access, a response of liquid crystals and a light transmission are sequentially performed. If the display panel 207 adopts the FSC-scheme, when the three color LED chips are used as a light source, the three color LED chips can be sequentially operated into ON/OFF operations.

As shown FIG. 6, a plurality of substrates 320 are arranged in the form of a bar on the light emitting unit 310, which is disposed in the bottom cover 301. The driving circuit 350 is disposed at a side of the substrate 320. The driving circuit 350 sequentially turns on the three color LED chips of the light emitting diode 330 which is mounted on the substrate 320.

Since the driving circuit 350 is disposed on each of the substrates 320, the driving circuit 350 is connected to the three color LED chips of the light emitting diode 330, which is disposed on the substrate, through four signal lines. The three color LED chips are sequentially turned on/off by the driving circuit 350. The driving circuit 350 is disposed at each of the substrates 320 or is individually disposed on the light emitting unit 310.

The display device 300 having the light emitting unit 310 can be applied to a computer or a display device for a digital broadcast.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

According to the embodiment, ON/OFF operations of a red LED, a green LED and a blue LED are controlled by a 2-bit control signal.

According to the embodiment, a red LED, a green LED and a blue LED are sequentially turned on/off by a 2-bit control signal.

According to the embodiment, two electrodes of three color LEDs are connected through four signal lines, so that a line pattern of a substrate is simplified and a sufficient space is ensured for the substrate.

The embodiment provides a control circuit for a light emitting diode, which is applied to the FSC type display device, and a light unit having the same.

1. A control circuit for a light emitting diode, the control circuit comprising:
a red LED, a green LED and a blue LED;
a driver which outputs a first control signal and a second control signal based on a 2-bit combination; and
a driving circuit which sequentially turns on/off the LEDs according to a state of the first control signal and the second control signal that are output from the driver.

2. The control circuit as claimed in claim 1, wherein at least one of the red LED, the green LED and the blue LED comprises at least one LED.

3. The control circuit as claimed in claim 1, wherein the red LED, the green LED and the blue LED are comprised in a form of a chip so as to be packed in a package.

4. The control circuit as claimed in claim 1, wherein the driving circuit operates the LEDs into an OFF-mode or an ON-mode according to colors based on the first control signal and the second control signal.

5. The control circuit as claimed in claim 1, wherein the driving circuit comprises:
a first inversion logic device which inverts the first control signal and outputs the inverted first control signal:
a second inversion logic device which inverts the second control signal and outputs the inverted second control signal:
a first AND logic device which ANDs the first control signal and an output signal of the second inversion logic device and outputs a resultant signal;
a second AND logic device which ANDs an output signal of the first inversion logic device and the second control signal and outputs a resultant signal; and
a third AND logic device which ANDs the first control signal and the second control signal and outputs a resultant signal.

6. The control circuit as claimed in claim 5, wherein the first to third AND logic devices are connected to first electrodes of the color LEDs, respectively.

7. The control circuit as claimed in claim 1, wherein the driver outputs the first control signal and the second control signal having the bit combination during a single period or a single frame.

8. A light emitting device comprising:
a package body having a cavity;
first to third color LEDs disposed in the cavity;
a driving circuit, which is connected to first electrodes of the first to third color LEDs in a predetermined area of the package body to turn on/off the first to third color LEDs;
a plurality of control signal terminals, which are disposed at a first side of the package body and are connected to the driving circuit; and
a ground terminal, which is disposed at a second side of the package body and is connected to a second electrode of the first to third colors.

9. The light emitting device as claimed in claim 8, wherein the package body comprises a multi-layer substrate or silicon material.

10. The light emitting device as claimed in claim 8, wherein the driving circuit turns off the first to third color LEDs and sequentially turns on the color LEDs according to a state of two control signals that are input into two control signal terminals of the plural control signal terminals.

11. The light emitting device as claimed in claim 8, wherein the first to third color LEDs comprise a chip type red LED, a chip type green LED and a chip type blue LED.

12. The light emitting device as claimed in claim 8, wherein the driving circuit comprises:
a first inversion logic device connected to a first control signal terminal of the plural control signal terminals;
a second inversion logic device connected to a second control signal terminal of the plural control signal terminals;
a first AND logic device which ANDs a first control signal and an output signal of the second inversion logic device to output a resultant signal to the first electrode of the first color LED;
a second AND logic device which ANDs an output signal of the first inversion logic device and a second control signal to output a resultant signal to the first electrode of the second color LED; and
a third AND logic device which ANDs the first control signal and the second control signal to output a resultant signal to the first electrode of the third color LED.

13. A light emitting device comprising:
a substrate, on which a light emitting diode comprising first to third LED chips is disposed in a form of an array;
a driving circuit connected to a first electrode and a second electrode of the LED chips through four signal lines to sequentially operate the LED chips; and
a driver, which outputs a first control signal and a second control signal having a 2-bit combination to the driving circuit.

14. The light emitting device as claimed in claim 13, wherein the driving circuit is disposed at a side of a substrate.

15. The light emitting device as claimed in claim 13, further comprising a bottom cover on which a substrate is disposed.

16. The light emitting device as claimed in claim 15, wherein at least one of a diffusion sheet and a prism sheet is disposed on the bottom cover.

17. The light emitting device as claimed in claim 15, further comprising a light guide plate which is disposed at a side of the substrate.

18. The light emitting device as claimed in claim 17, wherein an optical sheet is disposed at an upper side of the light guide plate, and a reflection plate is disposed at a lower side of the light guide plate.

19. The light emitting device as claimed in claim 13, wherein the driving circuit comprising:
a first inversion logic device which inverts the first control signal:
a second inversion logic device which inverts the second control signal:
a first AND logic device which ANDs the first control signal and an output signal of the second inversion logic device and outputs a resultant signal to the first electrode of the first color LED chip;
a second AND logic device which ANDs an output signal of the first inversion logic device and the second control signal and outputs a resultant signal to the first electrode of the second color LED chip; and
a third AND logic device which ANDs the first control signal and the second control signal and outputs a resultant signal to the first electrode of the third color LED chip.

20. The light emitting device as claimed in claim 13, wherein the first to third color LED chips comprise a red LED chip, a green LED chip and a blue LED chip.
